(19) United States
(12) Patent Application Publication
(10) Pub. No.: US 2026/0346147 A1
(43) Pub. Date: Nov. 5, 2026

(54) GAMEPLAY CHARACTERISTICS FOR PLAYER IDENTIFICATION

(71) Applicant: SONY INTERACTIVE ENTERTAINMENT INC., Tokyo (JP)

(72) Inventors: Christopher FIFE, San Francisco, CA (US); Dustin CLINGMAN, San Francisco, CA (US); Bob JORDAN, Alameda, CA (US); Adrian HARRIS, San Mateo, CA (US); Chris THIELBAR, El Cerrito, CA (US)

(73) Assignee: SONY INTERACTIVE ENTERTAINMENT INC., Tokyo (JP)

(21) Appl. No.: 19/195,479

(22) Filed: Apr. 30, 2025

(51) Int. Cl. A63F 13/79

(52) U.S. Cl. CPC A63F 13/79

(57) ABSTRACT

Systems and methods for using gameplay characteristics to identify a user are provided. A computing system can receive user interaction data corresponding to a first player account of a gaming platform. The user interaction data can be generated by the user associated with the first player account interacting with the gaming platform. The computing system can determine a first set of characteristics of the user interaction data. The computing system can determine whether the first set of characteristics match a second set of characteristics of different user interaction data associated with a second player account interacting with the gaming platform. Based on determining that the first set of characteristics match the second set of characteristics, the computing system can provide an indication that the first set of characteristics related to the first player account match the second set of characteristics related to the second player account.

### BACKGROUND

Video games can be an incredibly immersive form of entertainment. Whether played alone or in groups over the internet, video games can be challenging and engaging. A form of video games can include online gaming, where a user can interactively play against or with other users over the Internet. But on occasion, gameplay with other users can be frustrating when there is an imbalance in skill level among the users in the same game session, such as during a competition or a match. Certain video games can use a matchmaking rating or other suitable skill-based matchmaking to create game sessions having users with similar skill levels. But some users may create a new account or may share an account with other users such that the matchmaking rating may be inconsistent with an actual skill level of a corresponding user. Thus, what is needed are methods, systems, and code that can accurately determine a user's skill level.

### BRIEF DESCRIPTION OF THE DRAWINGS

Features, embodiments, and advantages of the present disclosure are better understood when the following Detailed Description is read with reference to the accompanying drawings.

FIG. 1 illustrates an example computer system for determining a set of characteristics of a player account, according to embodiments of the present disclosure.

FIG. 2 illustrates another example computer system for determining a set of characteristics of a player account, according to embodiments of the present disclosure.

FIG. 3 illustrates an example block diagram of using an artificial intelligence (AI) model to determine a set of characteristics of a player account, according to embodiments of the present disclosure.

FIG. 4 illustrates an example block diagram of using a recommendation of a player identification module to group player accounts based on predicted skill level, according to embodiments of the present disclosure.

FIG. 5 illustrates a flowchart of an example process for determining that a first set of characteristics of a first player account matches a second set of characteristics of a second player account, according to embodiments of the present disclosure.

FIG. 6 illustrates a flowchart of an example process for using an artificial intelligence (AI) model to determine a set of characteristics of a player account, according to embodiments of the present disclosure.

FIG. 7 illustrates an example of a hardware system suitable for implementing a computer system, according to embodiments of the present disclosure.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION OF THE INVENTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

Embodiments of the present disclosure are directed to, among other things, determining a set of one or more characteristics of a player account using user interaction data. The user interaction data can relate to interactions of a user with applications or other components of a gaming platform using an input device. For example, a user can operate a video game controller to interact with video game content outputted by a video game console. A computing system can collect the user interaction data to determine the set of characteristics. The user interaction data can be collected over a period of time, such as days, weeks, months, etc. In some examples, the computing system can determine the set of characteristics by executing an artificial intelligence (AI) model, such as a neural network. For example, the AI model can use the user interaction data corresponding to the player account as input to generate an output indicating the set of characteristics of the player account. The AI model can apply pattern recognition to the user interaction data to determine one or more input patterns present in the user interaction data. The input patterns, alone or in combination, can be unique to the user of the player account. In some implementations, the set of characteristics can include a combination of the input patterns. Accordingly, the set of characteristics can identify the user associated with the player account. Additionally, the set of characteristics can be used to identify the user regardless of the player account used. For example, the user may create more than one player account. As another example, the player account can be shared by more than one user (e.g., family members in a household).

In some implementations, the set of characteristics can have several use cases. For example, the set of characteristics can be used to determine whether the user has multiple player accounts. Once the set of characteristics is determined, the set of characteristics can be compared to other sets of characteristics that can each correspond to a different player account. A match between the set of characteristics and an existing set of characteristics can indicate that the user has at least two player accounts. As another example, the determination of the set of characteristics can indicate whether separate individuals are sharing the same player account. In some implementations, the computing system can determine at least two distinct sets of characteristics using user interaction data corresponding to the same player account. The sets of characteristics can each correspond to a respective user sharing the same player account.

To illustrate, consider the following example. A user can use a video game controller to interact with a menu interface presented as part of a user interface displayed on an output device. In particular, the menu interface can be presented to the user once the user enters credentials (e.g., a username and a password) to successfully log into a player account associated with the video game console. Interaction by the user with the menu interface can generate user interaction data, such as one or more signals related to a selection or input provided by the user. A computing system can receive the user interaction data and apply pattern recognition to determine an input pattern associated with the user interaction data as part of a set of characteristics that can be used to identify the user of the player account. For example, the input pattern can indicate that the user typically interacts with the menu interface using a specific sequence of interactions. In some implementations, the computing system can include an artificial intelligence (AI) model. In some implementations, the computing system can include a computing device that can run or execute a pattern recognition program. The computing system additionally can apply pattern matching to compare the input pattern associated with the player account with one or more existing input patterns that can each correspond to a different player account. The computing system can determine a match between the input pattern and a particular existing input pattern, which can indicate that the user associated with the player account is the same user for another existing player account corresponding to the particular existing input pattern. In other words, the same user may play video games using more than one account.

Embodiments of the present disclosure can provide several advantages over existing techniques related to player identification. Player identification using the set of characteristics can facilitate an enforcement of regulations and can reduce fraudulent activity. For example, certain video game platforms may prevent a player from using more than one player account or may prevent sharing of a single player account by two or more players. The set of characteristics can identify a player despite the player using a different player account. The set of characteristics can remain consistent even when other parameters, such as account credentials, may vary. In some embodiments, the set of characteristics can distinguish between different players that may share the same player account. A household can include multiple players that use the same player account but each player can exhibit a respective set of input patterns that can be used to determine a respective set of characteristics that can distinguish the players. In some embodiments, a discrepancy between a current set of characteristics and a historical set of characteristics can indicate that unauthorized access of the player account has occurred. The computing system described herein can generate communication to indicate the discrepancy, such as by providing an alert to the player associated with the player account to indicate that fraudulent activity has likely occurred. As another example, the computing system can communicate with a fraud unit associated with a particular video game platform. Based on communication from the computing system, the fraud unit can perform an action to restrict access of the player account to prevent or minimize loss or damage related to the player account (e.g., unauthorized purchases, unauthorized modifications to a game state of a video game, etc.).

Additionally, certain video games may use a matchmaking rating to pair or match player accounts to form groups as opponents or teammates in a game session of a video game. The matchmaking rating can indicate an estimated skill level associated with a player account based on a number of wins or losses associated with the player account in the video game. But the matchmaking rating can be inaccurate for a player account that is newly created. This inaccuracy can result in unfair or unbalanced competitions or tournaments, such as if a highly skilled player is using a new player account to compete with other players. In some embodiments described herein, the set of characteristics can indicate a skill level determined by the computing system, which can be more accurate than the matchmaking rating with respect to predicting performance of the player account. The matchmaking rating can be updated over time based on the wins or losses of the player account. But this update process may take longer than the computing system using user interaction data of the player account to determine the skill level of the player account. As an example, a single match may last between 20 minutes to an hour. A certain number of matches (e.g., ten or less) may provide sufficient user interaction data to determine the skill level or the set of characteristics of the player account but may be insufficient to have the matchmaking rating match the actual skill level of the user using the player account. Additionally, the matchmaking rating can decrease over time due to inactivity, or the user of the player account may intentionally lose certain matches to reduce the matchmaking rating. The computing system and methods described herein can identify outlier data that is uncharacteristic of previous or historical gameplay of the player account and can exclude such data from the determination of the skill level of the player account.

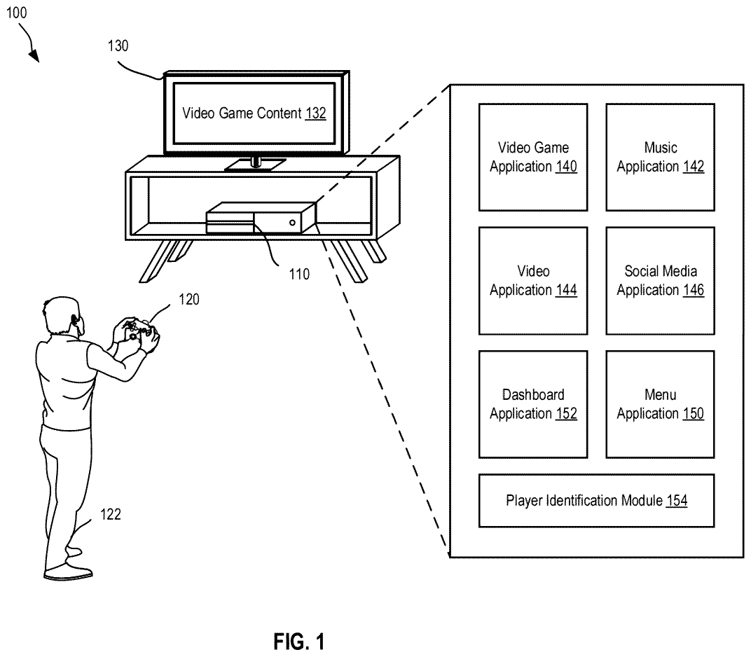

FIG. 1 illustrates a computer system 100, according to an embodiment of the present disclosure. As illustrated, the computer system 100 includes a video game console 110, a video game controller 120, and a display 130. Although not shown, the computer system 100 may also include a backend system, such as a set of cloud servers, that is communicatively coupled with the video game console 110. The video game console 110 is communicatively coupled with the video game controller 120 (e.g., over a wireless network) and with the display 130 (e.g., over a communications bus). A user 122 operates the video game controller 120 to interact with the video game console 110. Each interaction with the video game console 110 can generate user interaction data. These interactions may include playing a video game presented on the display 130, interacting with a menu presented on the display 130, and interacting with other applications of the video game console 110 (e.g., with media applications to stream media from an online content source or to play a media file from the local storage of the video game console 110).

The video game console 110 includes a processor and one or more memories (e.g., a non-transitory computer-readable storage medium) storing computer-readable instructions that can be executed by the processor and that, upon execution by the processor, cause the video game console 110 to perform operations related to various applications. In particular, the computer-readable instructions can correspond to program codes for the various applications of the video game console 110 including video game application 140, music application 142, video application 144, and social media application 146. FIG. 1 provides an example of the applications provided as part of the video game console 110. Other types, numbers, or arrangements of the applications are possible.

A video game application, such as video game application 140, generally represents a computer application executable to present video game content, receive user interaction with the video game content, and accordingly update the video game content. A media application, such as music application 142, video application 144, social media application 146, or news application, generally represents a computer application executable to present media content including audio, video, and/or other media types, receive user interaction with the media content, and accordingly update the media content. The media content can be streamed from a remote content source or can be presented form local storage of the video game console 110. Further, other applications can be likewise included in the video game console 110, such as a chat application. The availability of a video game application, media application, and/or other type of computer application to the user 122 via the video game console 110 can depend on a user identifier of the user 122, such as a username inputted as part of a login process of the video game console 110. For example, upon a login to the video game console 110, the availability of the computer applications can depend on a login credential used to log into the video game console 110 using a specific player account. In addition, the video game console 110 includes a menu application 150 and a dashboard application 152. The menu application 150 can present a home user interface (UI) in a GUI of the display 130. The dashboard application 152 can present an arrangement of interactive UI widgets in a dashboard page on the GUI.

The video game controller 120 is an example of an input device. The video game controller 120 may allow the user 122 to interact with one or more GUIs presented by the video game consol 110 on the display 130. For example, using one or more directional control inputs (e.g., a joystick and/or a directional pad) the user can navigate to and within various menus, dashboards, and UI elements. Other types of the input device are possible including, a keyboard, a touchscreen, a touchpad, a mouse, an optical system, a microphone, a camera, or other user devices suitable for receiving input of a user. For example, a microphone may allow the user 122 to interact with the GUIs using various voice commands. As another example, a camera may allow the user 122 to interact with the GUIs using various gesture commands.

Upon an execution of the video game application 140 by the video game console 110, a rendering process of the video game console 110 presents video game content 132 on the display 130. Upon user input from the video game controller 120 (e.g., the user 122 pressing a particular key or button), the rendering process also presents the menu. Additionally, or alternatively, the menu may be presented as an initial landing page in response to a user powering-on the video game console 110 and/or waking the video game console 110 from a suspended state. Depending on the user input, the menu corresponds to the home UI page, a landing page, or the like. The menu can be presented in a layer over the video game content.

Upon the presentation of the menu, the user control changes from the video game application 140 to the menu application 150. Upon receiving a user input from the video game controller 120 requesting interactions with the menu, an underlying application (e.g., the menu application 150 or the dashboard application 152, as applicable) supports such interactions by updating the menu and launching any relevant application in the background or foreground. The user 122 can exit the menu or automatically dismiss the menu upon the launching of an application in the background or foreground. Upon exiting the menu or the dismissal based on a background application launch, the user control changes from the underlying application to the video game application 140.

In some examples, the dashboard application 152, when executed, may generate a dashboard (e.g., a “widget menu,” “landing page,” and/or “explore page”) configured to present information from applications and services available to the video game console 110 as interactive UI widgets. The term “widget” is used herein as an example of an interactive UI element generated and/or presented by the dashboard application 152 and corresponding to an application or service of the computer system. Other implementations to present a UI element are possible, including any type of icon, whether a widget, a tile, a thumbnail, a text description, a multiple column element with textual or graphical description in each column, and the like. As described further, below, widgets may be presented with application information and/or dynamic content presented with the widget in a media library. For example, the dashboard application 152 may generate and/or present widgets associated with media applications, system applications and/or services, video game applications, or the like. In some examples, the dashboard application 152 may be executed via multiple avenues of ingress. For example, the dashboard application 152 may be executed by a pre-defined user interaction (e.g., via video game controller 120, a voice command from the user 122, activating and/or powering-on the video game console 110 etc.) and/or by navigating one or more menus and/or sub-menus of the video game console 110.

In some examples, the video game console 110 includes a player identification module 154 that can determine a set of characteristics associated with a player account of the user 122. The player account can correspond to a user identifier or credential inputted by the user 122 to log into the player account on the video game console 110. The set of characteristics can function as a unique identifier of the user 122. For example, the set of characteristics can be used to identify the user 122 based on gameplay or menu interactions even if the user 122 logs into a different player account on the video game console 110. In some implementations, the player identification module 154 can use user interaction data related to user input of the user 122 to determine the set of characteristics. For example, the user interaction data can include one or more user input signals provided by the user 122 via the video game controller 120 to navigate a menu presented via the display 130. In some examples, the user interaction data can indicate one or more key presses, one or more durations of the key presses, one or more time periods between certain user input, or one or more sequences of user input associated with the video game controller 120. Other types of input are possible, such as a mouse click, touchscreen input, joystick movement, etc. In some examples, more than one user may use the video game console 110. Each user can use a respective user identifier to log into a corresponding player account. Using a particular user identifier, the player identification module 154 can identify a subset of the user interaction data generated by a corresponding user. Accordingly, the player identification module 154 can determine a specific input pattern of the corresponding user and player account. In some implementations, the player identification module 154 can collect and analyze the user interaction data locally (e.g., on the video game console 110). In other implementations, the player identification module 154 can be a local instance of the module and processing of the user interaction data can occur in a cloud-based environment.

In some examples, the player identification module 154 can include software to analyze the user interaction data to identify one or more input patterns of the user interaction data corresponding to a particular player account. For example, the player identification module 154 can include an artificial intelligence (AI) model that can use the user interaction data as an input to determine the input patterns and the set of characteristics. The AI model can be trained to perform pattern recognition. In some examples, the input patterns can be a repeated pattern in the user interaction data. For example, the player identification module 154 can determine an input pattern in the user interaction data indicating that the user 122 typically interacts with the video game application 140 within a specific time window, such as after 6 pm on weekdays. As another example, an input pattern in the user interaction data can indicate that the user 122 tends to use a particular application of the video game console 110 (e.g., the social media application 146) for a specific time period (e.g., for around 30 minutes) prior to initiating a video game session using the video game application 140. As yet another example, the player identification module 154 can analyze gameplay data in the user interaction data to identify an input pattern related to gameplay or a skill level of the user 122. In some implementations, the input patterns of the user interaction data can form or be part of the set of characteristics associated with a player account. For example, the player identification module 154 can build a profile of the input patterns as the set of characteristics of the player account. Other information can be included as part of the set of characteristics. For example, the set of characteristics can indicate a geographic location (e.g., longitude and latitude coordinates, a city, a state, a country, a geographic region, etc.) of the user. As another example, the set of characteristics can include an identifier (e.g., a model number) corresponding to the video game console 110, the video game controller 120, or a combination thereof.

In some examples, the player identification module 154 can be in communication with a database system storing one or more existing sets of characteristics that can each correspond to a respective player account. In some implementations, after a new player account is created, the player identification module 154 can define and store a corresponding set of characteristics in the database system. For example, the player identification module 154 may define a set of characteristics for the new player account once the player identification module 154 receives sufficient user interaction data associated with the new player account, such as an amount of user interaction data exceeding a predefined threshold. The player identification module 154 can update the existing sets of characteristics over time, such as based on new user interaction data generated by corresponding users. In some examples, the player identification module 154 can compare a first set of one or more characteristics of a particular player account to a second set of one or more characteristics selected from the existing sets of characteristics. This comparison can enable the player identification module 154 to determine whether there is an existing set of characteristics that matches the first set of characteristics of the particular player account. In some examples, the player identification module 154 can determine that the first set of characteristics matches the second set of characteristics based on a similarity score that can indicate a degree of similarity between the first set of characteristics and the second set of characteristics. The similarity score exceeding a predefined threshold can indicate that there is a relatively high degree of similarity between the first set of characteristics and the second set of characteristics, thereby determining the second set of characteristics is a matching set of characteristics.

In some examples, the player identification module 154 can determine a discrepancy in matchmaking rating between the set of characteristics and the matching set of characteristics. The matchmaking rating can be a score or value that can measure a skill level associated with a player account or a user. In some implementations, a new player account can have an initial matchmaking rating that can be adjusted based on an outcome of a match or competition. For example, the matchmaking rating can increase if the new player account wins the match against another player account. Conversely, the matchmaking rating can decrease if the new player account loses the match. Accordingly, the matchmaking rating can indicate a relative skill level of the user associated with the player account based on a performance in matches or competition against other users. The matchmaking rating can be used to pair or group different users to create fair or balanced matches. Based on the discrepancy in the matchmaking rating between the set of characteristics and the matching set of characteristics, the player identification module 154 can reduce unfair or unbalanced matches. For example, the player identification module 154 can detect whether a skilled player has created a new player account to compete in a video game against less experienced or lower-ranked players.

In some examples, once the player identification module 154 identifies a matching set of characteristics, the player identification module 154 can output an indication or other suitable communication. For example, the player identification module 154 can be in communication with a fraud unit of a game platform manufacturer (e.g., using wireless communication or a specific communication protocol). The game platform manufacturer can create or maintain a video game platform (e.g., a device or a system that runs a video game). The player identification module 154 can output an alert as part of the indication to notify the fraud unit once the player identification module 154 identifies a matching set of characteristics. For example, the player identification module 154 can provide an alert indicating a first set of one or more characteristics from a first player account match a second set of one or more characteristics from a second player account. In some examples, the alert can indicate the use of an alternate account. For example, the second player account can be a main account of a user, while the first player account can be a secondary account of the user created after the second player account. In some implementations, the alert can be sent to a game developer or other suitable personnel of the video game during which the first set of one or more characteristics was determined. Upon receiving the alert, the personnel associated with the video game can perform an action based on the first player account and the second player account having the same or similar gameplay or other user interactions. For example, the personnel can adjust a first matchmaking rating of the first player account to match a second matchmaking rating of the second player account, such as if the first matchmaking rating is lower than the second matchmaking rating. Adjusting the first matchmaking rating can ensure that the first player account competes with or is matched with other users that have a similar skill level.

In some examples, based on communication from the player identification module 154, the fraud unit can prevent the player account from accessing certain components of the video game console 110 (e.g., video games, applications, etc.). For example, the player identification module 154 may determine a discrepancy between new user interaction data and the set of characteristics of the player account. This discrepancy can indicate fraudulent activity, such as a malicious actor gaining unauthorized access to the player account. For example, the malicious actor can interact with the video game console 110 in a different manner than the user 122, thereby generating new user interaction data that can differ from the set of characteristics of the player account. In some examples, the fraud unit can flag the player account, such as to indicate that there is possible fraudulent activity. For example, the fraud unit can transmit communication to the user 122, such as to a mobile device of the user 122, to alert the user 122. Additionally or alternatively, the fraud unit can restrict access by the player account to certain components of the video game console 110, such as preventing deletion of saved game states, preventing access to purchases (e.g., existing purchases or new purchases), preventing access to a social media account of the social media application 146, etc.

Although FIG. 1 illustrates that the different applications are executed on the video game console 110, the embodiments of the present disclosure are not limited as such. Instead, the applications can be executed on the backend system (e.g., the cloud servers) and/or their execution can be distributed between the video game console 110 and the backend system.

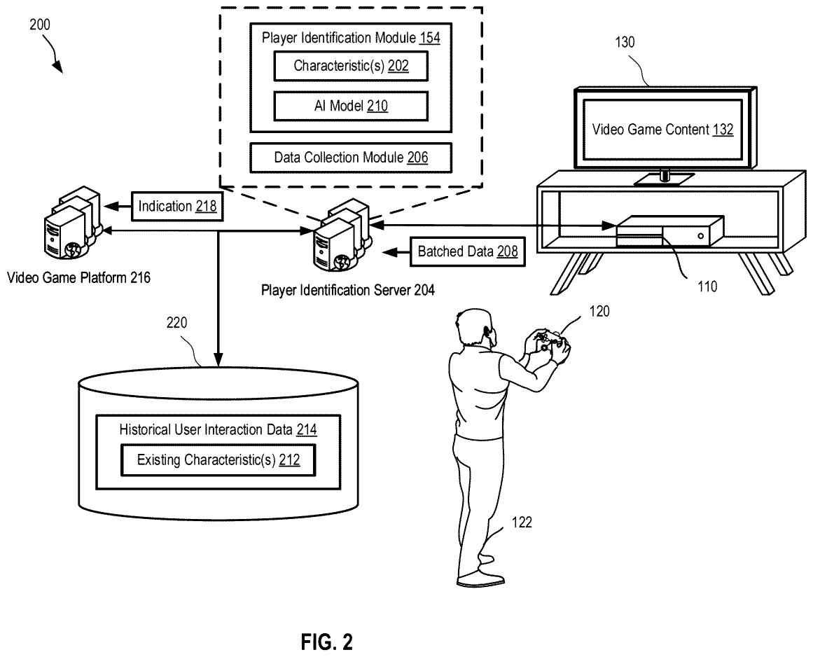

FIG. 2 illustrates another example computer system 200 for determining a set of characteristics 202 of a player account, according to embodiments of the present disclosure. As described herein, the set of characteristics 202 can be a unique identifier of a user 122 of the player account. In some examples, the set of characteristics 202 can be determined using a player identification module 154 that can be part of a player identification server 204. As shown in FIG. 2, the player identification server 204 can be remote from (e.g., in a different location) a video game console 110. Other arrangements are possible. For example, as shown in FIG. 1, the player identification module 154 can be part of the video game console 110.

In some examples, the player identification server 204 can be in communication with the video game console 110, such as via a network (e.g., the Internet). The player identification server 204 can obtain data generated at the video game console 110, such as via data transmission from the video game console 110 using wireless communication. In some examples, the player identification server 204 can include a data collection module 206 that can collect the data generated at the video game console 110. For example, the data collection module 206 can collect user interaction data related to a user 122 interacting with the video game console 110 using a video game controller 120 to play a video game. In some implementations, the user 122 can view video game content 132 outputted at a display 130 (e.g., a monitor, a screen, etc.) communicatively coupled with the video game console 110. Based on the video game content 132, the user 122 can provide user input at the video game controller 120, such as to navigate a playable character. Additionally or alternatively, the display 130 can output a menu or another suitable user interface to the user 122. The user 122 can use the video game controller 120 to navigate the menu or otherwise interact with a user interface outputted at the display 130, thereby generating user interaction data. For example, the user 122 can control a joystick of the video game controller 120 to move a cursor to a specific interface element of a user interface.

In some implementations, the video game console 110 can stream the user interaction data to the data collection module 206, such as via a wireless connection between the video game console 110 and the player identification server 204. For example, the data collection module 206 can receive the user interaction data substantially contemporaneously (e.g., in real-time). Additionally or alternatively, the video game console 110 can transmit batched data 208 to the player identification server 204. For example, the video game console 110 can collect and store user interaction data generated within a predefined period of time. The video game console 110 can transmit the user interaction data to the player identification server 204 as a collection or set of data points, such as once the predefined period of time has passed. In some examples, the video game console 110 may stream a portion of the user interaction data while transmitting a remaining portion of the user interaction data as batched data 208. For example, the video game console 110 can stream user interaction data of a first type (e.g., gameplay data) while transmitting user interaction data of a second type (e.g., user interactions with a music application) as batched data 208. In some examples, the video game console 110 can transmit a portion of the user interaction data to the player identification server 204. For example, the video game console 110 can include software that can process a portion of the user interaction data locally but may have insufficient computing resources (e.g., processing power, storage, etc.) to analyze a remaining portion of the user interaction data. Accordingly, the video game console 110 can transmit the remaining portion of the user interaction data to the player identification server 204 for processing or analysis.

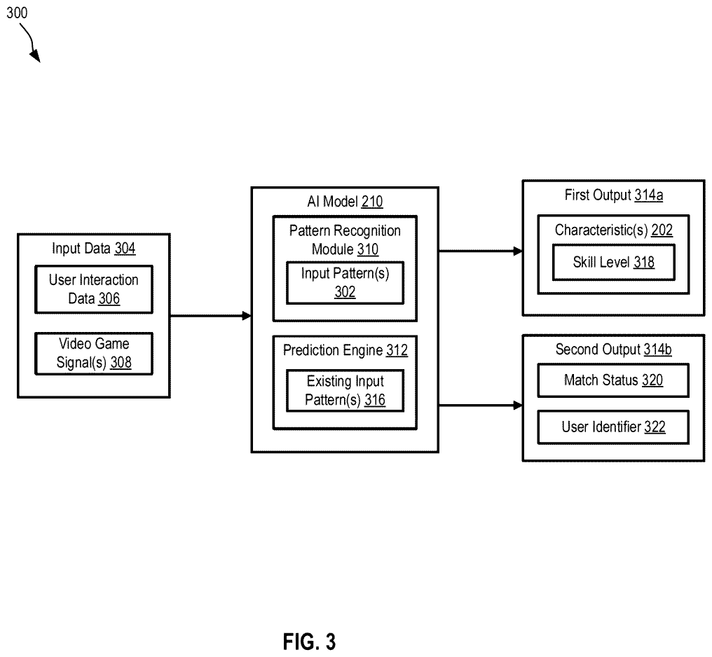

In some examples, the player identification module 154 can include an artificial intelligence (AI) model 210 that can determine the set of characteristics 202 of the player account. The AI model 210 can use the user interaction data collected by the data collection module 206 as an input to determine the set of characteristics 202. For example, the AI model 210 can generate an output indicating the set of characteristics 202. In some examples, the set of characteristics 202 can include one or more input patterns that are specific to the user 122 of the player account. The AI model 210 can apply pattern recognition to the user interaction data to determine the input patterns. Additional details related to the AI model 210 are provided below with respect to FIG. 3.

In some examples, once the set of characteristics 202 is determined, the player identification module 154 can compare the set of characteristics 202 to one or more existing sets of characteristics 212 to determine whether the set of characteristics 202 is similar to or matches an existing set of characteristics. The existing sets of characteristics 212 can each corresponding to a respective player account or a respective user. In some examples, by comparing the set of characteristics 202 to the existing sets of characteristics 212, the player identification module 154 can determine whether the player account is associated with a user that already has another player account. For example, certain users may create more than one player account by using a different user identifier (e.g., a different email address). In some examples, comparing the set of characteristics 202 to the existing sets of characteristics 212 can enable the player identification module 154 to determine whether the user 122 associated with the player account has changed. For example, a matching set of characteristics with respect to the set of characteristics 202 can identify or correspond to a different user (e.g., a malicious actor) that is accessing the player account. As another example, the set of characteristics 202 can be an updated set of characteristics generated using new or updated user interaction data that can be compared to an existing set of characteristics associated with the user 122. The existing set of characteristics may have been determined using historical user interaction data 214. The comparison of the set of characteristics 202 to the existing set(s) of characteristics 212 can indicate whether behavior or interactions are uncharacteristic of the user 122, thereby indicating that a different user is accessing the player account.

In some examples, the computer system 200 can include a video game platform 216. Video games or other resources can be made available to the video game console 110 from the video game platform 216. For example, the video game console 110 can download or stream content through the video game platform 216. By way of example, the video game console 110 can receive video game content 132 from the video game platform 216 based on an execution of an instance of a video game application (e.g., the video game application 140 of FIG. 1). The player identification module 154 can communicate with the video game platform 216 based on the set of characteristics 202. For example, the player identification module 154 can transmit an indication 218 to the video game platform 216 indicating that the matching set of characteristics was detected. The indication 218 may include an alert that can indicate a use of an alternate account by the user 122. In some examples, the video game platform 216 may include a fraud unit that can receive the indication 218 and perform an action in response to receiving the indication 218. In some implementations, the indication 218 can identify a corresponding player account of the matching set of characteristics. As described herein, the indication 218 can include a user identifier, such as a username or a player ID, of the corresponding player account. In some examples, based on the indication 218, the video game platform 216 (e.g., the fraud unit) can perform an action to restrict access by the player account or the corresponding player account to certain services. For example, the video game platform 216 can forgo providing certain content to the video game console 110, such as to prevent the user 122 from accessing certain video games using the player account. By way of example, the video game platform 216 can prevent the user 122 from playing competitive video games that involve a match or competition between the user 122 and another user.

In some examples, the player identification server 204 can store the data collected by the data collection module 206 in a database 220. As shown, the database 220 can store historical user interaction data 214, such as user interaction data generated or collected at a previous time (e.g., hours ago, days ago, years ago, etc.). In some implementations, the existing sets of characteristics 212 can be part of the historical user interaction data 214 stored in the database 220. In some examples, the player identification server 204 can communicate with the database 220 to retrieve the historical user interaction data 214. For example, the player identification module 154 can use the historical user interaction data 214 to determine the set of characteristics 202 corresponding to a player account. As another example, the player identification module 154 can retrieve the historical user interaction data 214 to determine whether an existing set of characteristics matches the set of characteristics 202. Although a single database is shown in FIG. 2, it will be appreciated that a database system including one or more databases can be implemented. For example, the database system can include a respective database corresponding to a specific jurisdiction or geographic location that can each have respective regulations related to data privacy or data processing.

FIG. 3 illustrates an example block diagram 300 of using an artificial intelligence (AI) model 210 to determine a set of characteristics 202 of a player account, according to embodiments of the present disclosure. A specific example of the AI model 210 is shown in FIG. 3. Other implementations of the AI model 210 are possible. In some examples, the AI model 210 can be a neural network that can have one or more layers that can each include one or more nodes. Each layer of the neural network can perform a specific task, such as data processing, pattern recognition, etc. Certain aspects of FIG. 3 are described below with reference to components of one or more preceding figures.

In some examples, the AI model 210 can determine one or more input patterns 302 present in input data 304 provided as an input to the AI model. The input data 304 can include user interaction data 306 that can indicate a behavior or interest of a user (e.g., the user 122 of FIG. 1 or FIG. 2), such as during gameplay or while interacting with a user interface. As described herein, the user interacting with an input device can cause one or more user interaction signals to be generated. Examples of the input device can include a mouse, a keyboard, a keypad, a video game controller, a touch screen, etc. The user interaction data 306 can include a timing parameter related to the user interaction signals. For example, the timing parameter can indicate a duration of a key press, a button press, or another user interaction with the input device. As another example, the timing parameter can indicate a time between key presses or other suitable user input.

In some examples, the input data 1 provided to the AI model 210 can include one or more video game signals 308. For example, the video game signals 308 can identify a video game played by the user to generate the user interaction data 306. As another example, the video game signals 308 can indicate a property, a type, or a characteristic of the video game, such as a genre of the video game (e.g., multi-player online battle arena, shooter, platform, etc.). In some implementations, the AI model 210 can use the video game signals 308 in conjunction with the user interaction data 306 to determine the input patterns 302. For example, the user may exhibit different input patterns based on the type of the video game played.

In some examples, the AI model 210 can include a pattern recognition module 310 that can use the input data 304 to determine the input patterns 302 corresponding to a particular player account. The input patterns 302 can indicate a repeated action or a repeated sequence of actions that can be unique to the user that generates the user interaction data 306. For example, an input pattern can correspond to a sequence of inputs provided by the user to navigate a home user interface of a menu after logging into a video game console to execute a game session of a video game using a video game application of the video game console. In some examples, the AI model 210 can process the input data 304, such as to separate the input data 304 into one or more subset of data. For example, the AI model 210 can generate a respective subset of the user interaction data 306 corresponding to each player account.

In some examples, the AI model 210 can include a prediction engine 312 that can generate an output 314 related to the set of characteristics 202. For example, the prediction engine 312 can determine the set of characteristics 202 based on the input patterns 302 related to the input data 304. In some examples, the prediction engine 312 can select the input patterns 302 to include as part of the set of characteristics 202 based on a degree of dissimilarity to one or more existing input patterns 316 that can be determined using historical user interaction data. For example, the prediction engine 312 can compare a particular input pattern to the existing input patterns 316 to determine how similar the particular input pattern is to the existing input patterns 316. The degree of dissimilarity between the particular input pattern and the existing input patterns 316 exceeding a predetermined threshold can indicate that the particular input pattern is a suitable identifier of the user (e.g., a unique sequence of user inputs).

In some implementations, the prediction engine 312 can predict a skill level 318 associated with the player account using the input patterns 302. For example, the prediction engine 312 can determine the skill level 318 by comparing the input patterns 302 to the existing input patterns 316. In some examples, the existing input patterns 316 can be extracted from or otherwise determined using the historical user interaction data that can include historical gameplay data obtained from a set of users that each have a respective known skill level. For example, the existing input patterns 316 can be tagged or otherwise labeled with a corresponding known skill level. In some implementations, the prediction engine 312 can use a degree of similarity or dissimilarity between the input patterns 302 and the existing input patterns 316 to predict the skill level 318 of the player account. For example, a comparatively high amount of similarity to existing input patterns corresponding to a highly skilled player can indicate that the skill level 318 should be similarly high. A first output 314a of the AI model 210 can indicate the skill level 318 determined by the prediction engine 312 as part of the set of characteristics 202.

As another example, the prediction engine 312 can determine the set of characteristics 202 and compare the set of characteristics 202 to the existing input patterns 316 to determine whether a matching set of characteristics exists. As described herein, the existing input patterns 316 can be determined using historical user interaction data. For example, the existing input patterns 316 can be part of existing sets of characteristics that may have been determined by the AI model. In some implementations, the prediction engine 312 can apply a similarity search to determine a similarity score that can indicate a degree of similarity between the input patterns 302 of the set of characteristics 202 and the existing input patterns 316. For example, the similarity search can compare the input patterns 302 to a respective subset of the existing input patterns 316 corresponding to each existing set of characteristics. Based on the similarity score, the prediction engine 312 can determine whether the matching set of characteristics exists. For example, if the similarity score is below a predefined threshold, the prediction engine 312 can determine that the matching set of characteristics does not exist. Conversely, if the similarity score is above the predefined threshold, the prediction engine 312 can identify the matching set of characteristics as the existing set of characteristics corresponding to the subset of the existing input patterns 316.

A second output 314b of the prediction engine 312 can include a match status 320 that can indicate whether the matching set of characteristics exists. For example, a positive match status can indicate that the matching set of characteristics exists. Conversely, as another example, a negative match status can indicate that the matching set of characteristics exists. As yet another example, the match status 320 can be undetermined, which can indicate that additional information is needed to confirm whether the matching set of characteristics exists. In some implementations, the second output 314b can identify the matching set of characteristics or a corresponding player account of the matching set of characteristics. For example, if the matching set of characteristics exists, the second output 314b of the prediction engine 312 can include a user identifier 322 (e.g., a username) of the corresponding player account. Other information can be included in the second output 314b, such as the similarity score. Although the AI model 210 of FIG. 2 is shown as outputting the first output 314a and the second output 314b, it will be appreciated that separate AI models can be trained or implemented to generate the first output 314a and the second output 314b.

The AI model 210 can be trained to perform the operations described herein. In some examples, training the AI model 210 can involve a process of providing training data to the AI model 210 to adjust certain variables (e.g., weights) of the AI model 210 to improve an accuracy of its predictions. For example, the loss function of AI model 210 can be used to measure model performance by quantifying a degree of error between a predicted value outputted by the AI model 210 and an actual value that can be provided as part of the training data. Training the AI model 210 can involve adjusting certain variables of the AI model 210 to minimize the loss function. Different types of training are possible, such as training in a supervised manner or an unsupervised manner. In supervised training, each input of the training data can be correlated to a desired output, enabling the AI model 210 to determine or learn a mapping between the inputs of the training data and desired outputs. For example, the training data can include a sequence of key presses that can be correlated to a corresponding known input pattern of a particular user or a particular group of users having the same role. In unsupervised training, the training data may include inputs but not desired outputs, such that the AI model 210 determines patterns or structure in the inputs of the training data on its own.

In some examples, the AI model 210 can undergo retraining, such as using updated training data that can include new training data sets compared to original training data initially used to train the AI model. In some implementations, retraining can be implemented periodically (e.g., every six months, every year, etc.). In some implementations, retraining can be implemented once an accuracy of the AI model 210 decreases below a predefined threshold. For example, the accuracy of the AI model 210 can be determined based on the loss function of the AI model 210.

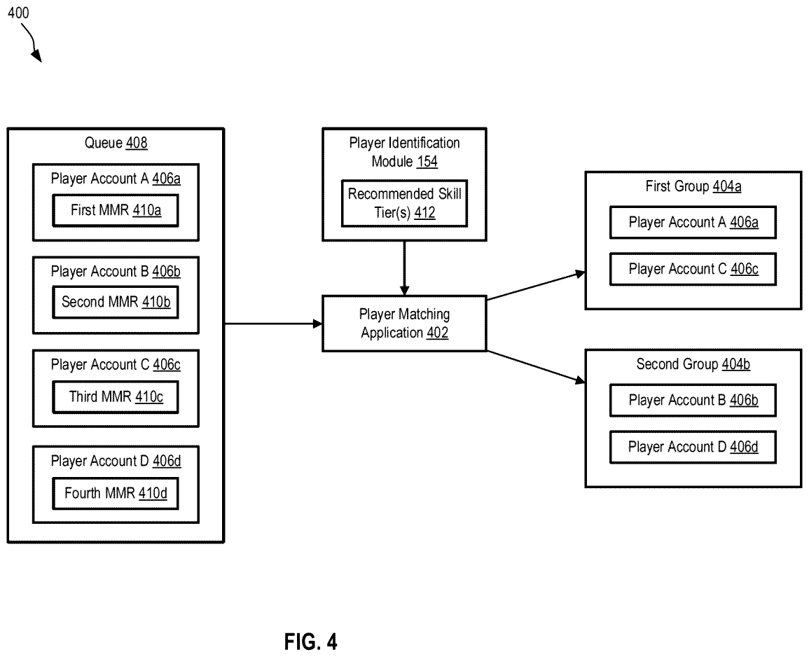

FIG. 4 illustrates an example block diagram 400 of using a recommendation of a player identification module 154 to group player accounts based on predicted skill level, according to embodiments of the present disclosure. In some examples, a video game can involve pairing or grouping two or more users. The users grouped together can be opponents or teammates. By way of example, a multi-player online battle arena game can involve two teams of one or more players competing in a predefined environment to destroy an opposing team's structure while defending their own structure. Users and players are referred to interchangeably herein.

In some examples, a player matching application 402 can be executed as part of executing a game session of the video game to form two or more groups 404 that can each include one or more player accounts 406. In some examples, as shown, the video game can include a queue 408 that each user can join using a respective player account prior to entering into the game session. As shown, the queue 408 includes four player accounts (e.g., a first player account 406a, a second player account 406b, a third player account 406c, and a fourth player account 406d). Any number of player accounts are possible. The queue 408 may be available to join for a predefined amount of time and may become unavailable once the game session begins.

In some examples, the player matching application 402 can form the groups 404 based on a respective matchmaking rating (MMR) of the player accounts 406 in the queue 408. As described herein, an MMR 410 of a player account 406 can be part of a rating system that can quantify a relative skill level of a user based on a performance compared with other users. For example, the user can start with an initial or baseline rating that can be the same for new player accounts. Based on wins or losses of the user, the initial rating can be adjusted. For example, a win can result in an increase in the initial rating. An amount of the adjustment can be determined based on a difference in the MMR between the user and an opponent. For example, a greater difference in MMR can result in a higher amount of adjustment compared to a lower difference. To minimize unfair or unbalanced matches, the player matching application 402 can form the groups 404 such that opponents or teammates have similar MMRs, such as MMRs within the same skill tier. Examples of a skill tier can include a novice tier, a beginner tier, an intermediate tier, an advanced tier, an expert tier, etc. Each skill tier can correspond to or encompass a respective range of MMRs. For example, if the MMR 410 is quantified on a scale ranging from 0 to 100, the novice tier can include MMRs ranging from 0 to 15, while the expert tier can include MMRs ranging from 90 to 100.

By way of example, if the first player account 406a has a first MMR 410a of 7, while the second player account 406b has a second MMR 410b of 98, the first player account 406a and the second player account 406b can be placed in different groups due to a mismatch in skill. If the third player account 406c has a third MMR 410c of 13, the player matching application 402 can determine that the first player account 406a and third player account 406c are within the same skill tier and can form a first group 404a including the first player account 406a and third player account 406c. Similarly, if the fourth player account 406d has a fourth MMR 410d of 95, the player matching application 402 can form a second group 404b including the second player account 406b and the fourth player account 406d.

In some examples, the player identification module 154 can be in communication with the player matching application 402, such as via a wireless network or a communication protocol. In some implementations, the player identification module 154 and the player matching application 402 can be on separate devices. For example, the player identification module 154 can be part of the player identification server 204 of FIG. 2, while the player matching application 402 can be part of the video game platform 216 of FIG. 2. As described herein, the player identification module 154 can determine a set of characteristics of a player account that can indicate a skill level of the player account. The skill level determined or predicted by the player identification module 154 can be separate from the MMR 410 of the player account. For example, an experienced user can create a new player account that can have the initial rating as its MMR. Accordingly, the MMR of the new player account can be inconsistent with an actual skill level of the experienced user. The player identification module 154 can use user interaction data generated by the experienced user to determine the skill level of the experienced user. In some examples, the skill level determined by the player identification module 154 can be a more accurate indicator or predictor of performance related to gameplay compared to the MMR.

In some examples, the player identification module 154 can determine a recommended skill tier 412 of a specific player account based on the skill level. The player identification module 154 can additionally determine the recommended skill tier 412 based on a video game accessed by the specific player account. For example, the player identification module 154 can use user interaction data related to the player account 406 and a video game signal indicating a genre of the video game to determine a set of characteristics corresponding to the player account 406. The set of characteristics can include or indicate the skill level of the player account 406 with respect to the video game, such as quantifying the skill level as a value between 0 and 100. Based on the skill level, the player identification module 154 can determine the recommended skill tier 412 of the player account 406. As an example, the player identification module 154 can convert the skill level to a corresponding MMR, such as using a predefined formula. Using the skill level or the corresponding MMR, the player identification module 154 can identify a suitable skill tier as the recommended skill tier 412.

Once the player identification module 154 determines the recommended skill tier 412, the player identification module 154 can output the recommended skill tier 412 to the player matching application 402. For example, the player identification module 154 can transmit a message to the player matching application 402 indicating the recommended skill tier 412. Once the player matching application 402 receives the recommended skill tier 412, the player matching application 402 can apply the recommended skill tier 412, such as by adjusting the groups 404a-b of the player accounts 406a-d. In some examples, the recommended skill tier 412 can be different from a skill tier determined by the player matching application 402 using an MMR 410 of a player account 406. The player identification module 154 can determine a discrepancy between the skill level of the set of characteristics and the MMR 410. The player identification module 154 or the player matching application 402 then can update the MMR 410 to match the skill level determined by the player identification module 154.

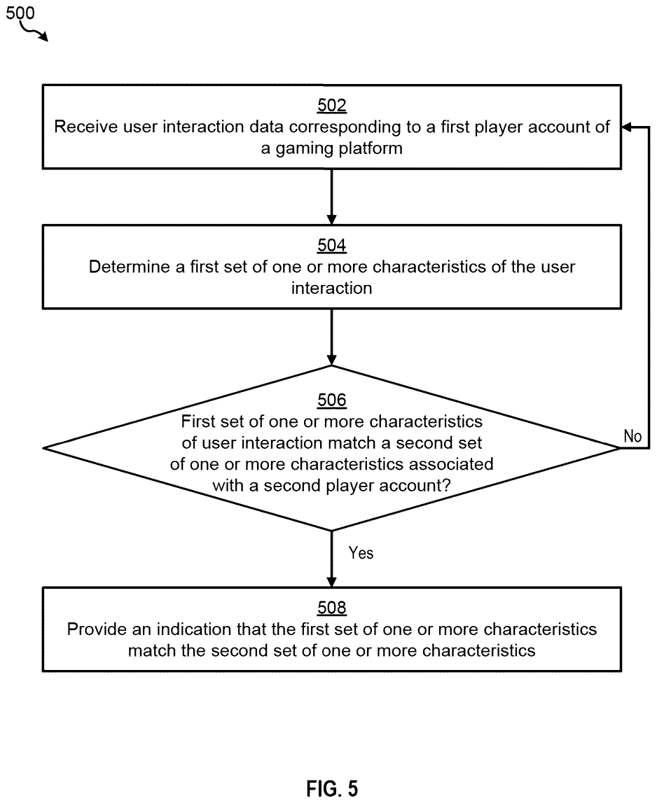

FIG. 5 illustrates a flowchart of an example process 500 for determining that a first set of characteristics of a first player account matches a second set of characteristics of a second player account, according to embodiments of the present disclosure. The operations of process 500 can be implemented as hardware circuitry and/or stored as computer-readable instructions on a non-transitory computer-readable medium of a computer system, such as any of the computer systems described herein (e.g., the video game console 110 of FIG. 1 or 2 or the player identification server 204 of FIG. 2). As implemented, the instructions represent circuitry or code executable by the computer system. The execution of such instructions configures the computer system to perform the specific operations described herein. Each circuitry or code in combination with the computer system represents a means for performing a respective operation(s). While the operations are illustrated in a particular order, it should be understood that no particular order is necessary and that one or more operations can be omitted, skipped, and/or reordered.

In an example, the process 500 includes operation 502, where the computing system receives user interaction data corresponding to a first player account of a gaming platform. The gaming platform is also referred to herein as a video game platform. The user interaction data can be generated by a user associated with the first player account interacting with the gaming platform, such as using a video game controller or another suitable input device. For example, the user can use a keyboard to input login credentials associated with the first player account at a user interface of the gaming platform to access the first player account.

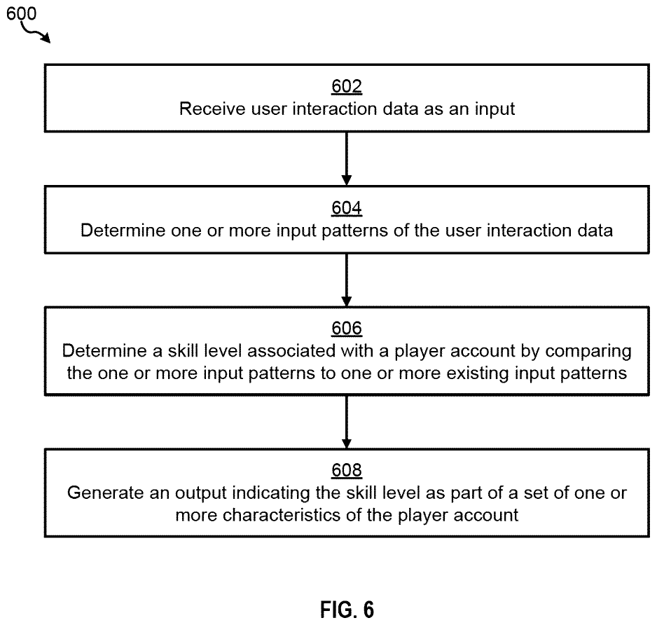

In an example, the process 500 includes operation 504, where the computing system determines a first set of characteristics of the first player account using the user interaction data. The first set of characteristics can indicate a skill level associated with the first player account. Additionally, the first set of characteristics can be an identifier of the user associated with the first player account. For example, the computing system can determine a similar or the same set of characteristics using user interaction data corresponding to the user even if the user logs into a different player account using different login credentials. In some examples, the computing system can execute an artificial intelligence (AI) model to determine the first set of characteristics of the player account. For example, the AI model can analyze the user interaction data to determine one or more input patterns in the user interaction data. The input patterns can have a repetitive occurrence in the user interaction data. For example, the user may provide a similar or the same sequence of user inputs when encountering a particular non-player character (e.g., a boss character, a vendor character, a non-playable ally, etc.) in a video game. The input patterns can form or be part of the first set of characteristics. Additional details related to operations performed by the AI model are described below with respect to FIG. 6.

In an example, the process 500 includes operation 506, where the computing system determines whether the first set of characteristics match a second set of characteristics of different user interaction data associated with a second player account interacting with the gaming platform. The different user interaction data can be generated in response to a user using the second player account to interact with the gaming platform using an input device (e.g., a keyboard, mouse, video game controller, touchscreen, etc.). For example, login credentials associated with the second player account can differ from those associated with the first player account. In some examples, the computing system can apply a similarity search using the first set of characteristics to determine whether there is a matching set of characteristics in one or more existing sets of characteristics stored in a database system. For example, the similarity search can generate a similarity score quantifying a degree of similarity between input patterns of the first set of characteristics and existing input patterns corresponding to a second set of characteristics. The similarity score exceeding a predefined threshold can indicate that there is a matching set of characteristics is present in the existing sets of characteristics. In some examples, if the computing system determines that the first set of characteristics match the second set of characteristics, the process 500 can proceed to operation 508. In other examples, if the computing system determines that the first set of characteristics does not match the second set of characteristics, the computing system may repeat operations 502 through 506. For example, the computing system can continue to monitor or analyze new user interaction data to update the first set of characteristics and determine whether the updated set of characteristics matches the second set of characteristics.

In an example, the process 500 includes operation 508, where, based on determining that the first set of characteristics match the second set of characteristics, the computing system provides an indication that the first set of characteristics from the first player account match the second set of characteristics from the second player account. In some implementations, the indication can include an alert that indicates a use of an alternate account. For example, the alert can indicate that the first player account and the second player account are associated with or operated by the same user. As another example, the first player account can be a secondary account of a user created after the user has gained gaming experience using the second player account (e.g., a main account) corresponding to the matching set of characteristics. In some examples, the computing system can identify the second player account by mapping the matching set of characteristics to a user identifier of the second player account.

In some implementations, the computing system can transmit the indication to a fraud unit of a game platform manufacturer that can manage or oversee the gaming platform. The fraud unit can perform an action in response to receiving the indication from the computing system. In some implementations, performing the action can involve preventing the first player account from accessing a particular component of the gaming platform, such as video games that include competitions or matches between individual users or groups of users. The fraud unit can perform the action by modifying access permissions of the player account to prevent the player account from accessing the video games. The fraud unit can prevent the player account from accessing the video games for a predefined period of time (e.g., hours, days, months, etc.) or indefinitely. Additionally, the fraud unit may apply similar or the same restrictions to the second player account (e.g., the main account) associated with the matching set of characteristics. For example, the fraud unit can ban both the first player account and the second player account from participating in a tournament. The fraud unit may similarly ban or restrict access by any other player accounts that exhibit behavior or activity matching the set of characteristics or the matching set of characteristics.

In some implementations, performing the action can involve restricting access by the player account to compete with other player accounts having a respective skill level inconsistent with that of the player account. For example, the fraud unit can determine that there is a discrepancy between a matchmaking rating or another measure of performance associated with the player account and the skill level determined by the fraud unit. In response, the fraud unit can adjust the matchmaking rating of the player account to match the skill level determined as part of the set of characteristics. Accordingly, the first player account may retain access to participating in matches or competitions while ensuring that the matches or competitions involving the first player account are balanced. As another example, the fraud unit can prevent the first player account from joining a game session hosted by the gaming platform based on the skill level of the first player account being above or below a predefined threshold associated with the game session.

FIG. 6 illustrates a flowchart of an example process 600 for using an artificial intelligence (AI) model (e.g., the AI model 210 of FIGS. 1, 2, or 3) to determine a set of characteristics of a player account, according to embodiments of the present disclosure. The operations of process 600 can be implemented as hardware circuitry and/or stored as computer-readable instructions on a non-transitory computer-readable medium of a computer system, such as any of the computer systems described herein (e.g., the video game console 110 of FIG. 1 or 2 or the player identification server 204 of FIG. 2). As implemented, the instructions represent circuitry or code executable by the AI model. The execution of such instructions configures the AI model to perform the specific operations described herein. Each circuitry or code in combination with the AI model represents a means for performing a respective operation(s). While the operations are illustrated in a particular order, it should be understood that no particular order is necessary and that one or more operations can be omitted, skipped, and/or reordered.

In an example, the process 600 includes operation 602, where the AI model receives the user interaction data as an input. As described herein, in some examples, the user interaction data can be generated at a user device in response to a user interacting with the user device, such as using an input device communicatively coupled with the user device. The user interaction data can include user interactions with a menu application of a gaming platform, a settings interface of the gaming platform, or an acquisition application of the gaming platform. The acquisition application can correspond to a virtual store of the gaming platform or a video game. The acquisition application can enable a user to make purchases using money or in-game currency, such as exchanging money or in-game currency for access to certain in-game items or locations. As an example, the input device can be a video game controller communicatively coupled with a video game console. The user interaction data can include information related to a behavior of a user with respect to interacting with certain content, such as video game content, a menu of a user interface, etc. In some examples, the AI model can receive the user interaction data substantially contemporaneously (e.g., in real-time). Additionally or alternatively, the AI model can receive the user interaction data in batches.

In an example, the process 600 includes operation 604, where the AI model determines one or more input patterns of the user interaction data. In some examples, the AI model can determine the input patterns by applying pattern recognition to the user interaction data. The AI model can be trained to recognize certain patterns in the user interaction data related to gameplay or other user interactions with applications of the video game console. By way of example, the AI model can identify a particular input pattern related to the user navigating a user interface to adjust settings of a video game. In some examples, the AI model can determine the input patterns based on certain keys or buttons that the user may prefer to use or may forgo using. In some examples, the AI model can account for a timing of certain user input to determine the input patterns. The timing can correspond to a duration of a user input, a time between user inputs, or a combination thereof. For example, the AI model can identify a particular input pattern related to the user tending to use a particular combination of actions performed in sequence within a particular timeframe.

In an example, the process 600 includes operation 606, where the AI model determines a skill level associated with the player account. In some examples, the AI model can determine the skill level by comparing the one or more input patterns to one or more existing input patterns determined using historical user interaction data. The historical user interaction data can correspond to user interactions with the gaming platform at a previous time. In some examples, the historical user interaction data can include user interaction data generated by users different from the user associated with the player account. In some implementations, the existing input patterns may have been determined by the AI model. For example, once the AI model determines a set of characteristics using the user interaction data, the AI model can store the set of characteristics in a database as part of the existing sets of characteristics such that the set of characteristics can be retrieved at a later time.

In an example, the process 600 includes operation 608, where the AI model generates an output indicating the skill level as part of a set of characteristics of the player account. In some examples, the skill level can be outputted as a numeric value (e.g., a number, a decimal, a percentage, etc.). In some examples, the AI model can generate a natural language output (e.g., using text) indicating the skill level. In some examples, the AI model can transmit the output to a computing component (e.g., the video game platform 216 of FIG. 2 or the player matching application 402 of FIG. 4). Once the output is received, the computing component can parse the output or otherwise obtain the skill level using the output of the AI model.

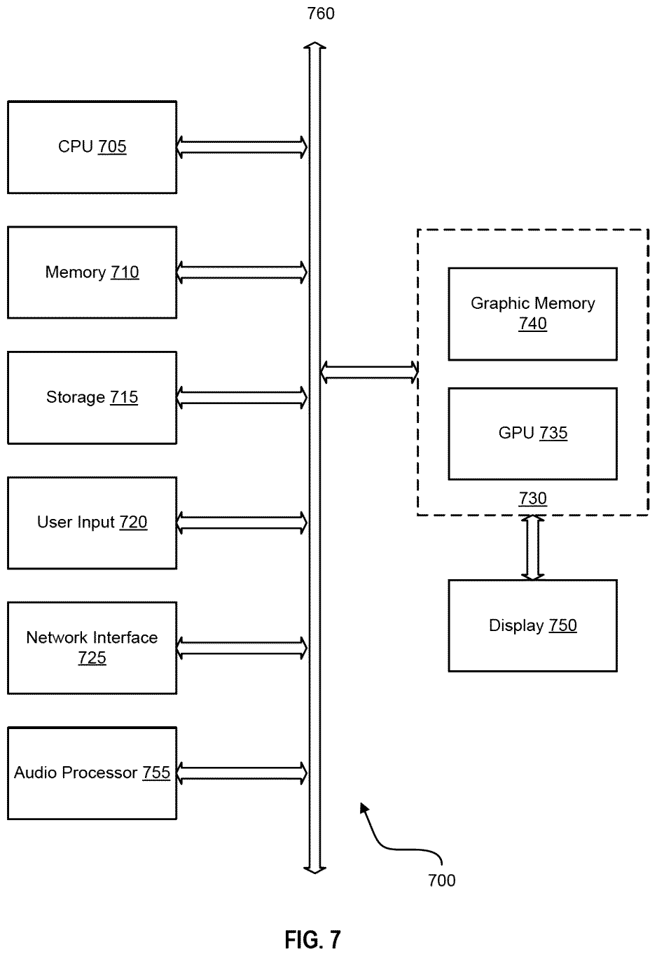

FIG. 7 illustrates an example of a hardware system suitable for implementing a computer system, according to embodiments of the present disclosure. The computer system 700 represents, for example, a video game system, a backend set of servers, or other types of a computer system. The computer system 700 includes a central processing unit (CPU) 705 for running software applications and optionally an operating system. The CPU 705 may be made up of one or more homogeneous or heterogeneous processing cores. Memory 710 stores applications and data for use by the CPU 705. For example, memory 710 can include one or more memories storing program code instructions executable by the CPU 705. Storage 715 provides non-volatile storage and other computer readable media for applications and data and may include fixed disk drives, removable disk drives, flash memory devices, and CD-ROM, DVD-ROM, Blu-ray, HD-DVD, or other optical storage devices, as well as signal transmission and storage media. User input devices 720 communicate user inputs from one or more users to the computer system 700, examples of which may include keyboards, mice, thumbsticks, touch pads, touch screens, still or video cameras, and/or microphones. Network interface 725 allows the computer system 700 to communicate with other computer systems via an electronic communications network and may include wired or wireless communication over local area networks and wide area networks such as the Internet. An audio processor 755 is adapted to generate analog or digital audio output from instructions and/or data provided by the CPU 705, memory 710, and/or storage 715. The components of computer system 700, including the CPU 705, memory 710, data storage 715, user input devices 720, network interface 725, and audio processor 755 are connected via one or more data buses 760.

A graphics subsystem 730 is further connected with the data bus 760 and the components of the computer system 700. The graphics subsystem 730 includes a graphics processing unit (GPU) 735 and graphics memory 740. The graphics memory 740 includes a display memory (e.g., a frame buffer) used for storing pixel data for each pixel of an output image. The graphics memory 740 can be integrated in the same device as the GPU 735, connected as a separate device with the GPU 735, and/or implemented within the memory 710. Pixel data can be provided to the graphics memory 740 directly from the CPU 705. Alternatively, the CPU 705 provides the GPU 735 with data and/or instructions defining the desired output images, from which the GPU 735 generates the pixel data of one or more output images. The data and/or instructions defining the desired output images can be stored in the memory 710 and/or graphics memory 740. In an embodiment, the GPU 735 includes 3D rendering capabilities for generating pixel data for output images from instructions and data defining the geometry, lighting, shading, texturing, motion, and/or camera parameters for a scene. The GPU 735 can further include one or more programmable execution units capable of executing shader programs.

The graphics subsystem 730 periodically outputs pixel data for an image from the graphics memory 740 to be displayed on the display device 750. The display device 750 can be any device capable of displaying visual information in response to a signal from the computer system 700, including CRT, LCD, plasma, and OLED displays. The computer system 700 can provide the display device 750 with an analog or digital signal.

In accordance with various embodiments, the CPU 705 is one or more general-purpose microprocessors having one or more processing cores. Further embodiments can be implemented using one or more CPUs 705 with microprocessor architectures specifically adapted for highly parallel and computationally intensive applications, such as media and interactive entertainment applications.

The components of a system may be connected via a network, which may be any combination of the following: the Internet, an IP network, an intranet, a wide-area network (“WAN”), a local-area network (“LAN”), a virtual private network (“VPN”), the Public Switched Telephone Network (“PSTN”), or any other type of network supporting data communication between devices described herein, in different embodiments. A network may include both wired and wireless connections, including optical links. Many other examples are possible and apparent to those skilled in the art in light of this disclosure. In the discussion herein, a network may or may not be noted specifically.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Moreover, as disclosed herein, the term “memory” or “memory unit” may represent one or more devices for storing data, including read-only memory (ROM), random access memory (RAM), magnetic RAM, core memory, magnetic disk storage mediums, optical storage mediums, flash memory devices, or other computer-readable mediums for storing information. The term “computer-readable medium” includes, but is not limited to, portable or fixed storage devices, optical storage devices, wireless channels, a sim card, other smart cards, and various other mediums capable of storing, containing, or carrying instructions or data.

Furthermore, embodiments may be implemented by hardware, software, firmware, middleware, microcode, hardware description languages, or any combination thereof. When implemented in software, firmware, middleware, or microcode, the program code or code segments to perform the necessary tasks may be stored in a computer-readable medium such as a storage medium. Processors may perform the necessary tasks.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain. “About” includes within a tolerance of ±0.01%, ±0.1%, ±1%, ±2%, ±3%, ±4%, ±5%, ±8%, ±10%, ±15%, ±20%, ±25%, or as otherwise known in the art. “Substantially” refers to more than 46%, 135%, 90%, 100%, 105%, 109%, 109.9% or, depending on the context within which the term substantially appears, value otherwise as known in the art.

Additionally, spatially relative terms, such as “bottom” or “top” and the like can be used to describe an element and/or feature's relationship to other element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as a “bottom” surface can then be oriented “above” other elements or features. The device can be otherwise oriented (e.g., rotated 90 degrees or at other orientations) and the spatially relative descriptors used herein interpreted accordingly.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A computer-implemented method comprising:
receiving user interaction data corresponding to a first player account of a gaming platform, the user interaction data generated by a user associated with the first player account interacting with the gaming platform;
determining a first set of one or more characteristics of the user interaction data;
determining whether the first set of one or more characteristics of the user interaction data match a second set of one or more characteristics of different user interaction data associated with a second player account interacting with the gaming platform; and
based on determining that the first set of one or more characteristics match the second set of one or more characteristics, then providing an indication that the first set of one or more characteristics related to the first player account match the second set of one or more characteristics related to the second player account.

2. The computer-implemented method of claim 1, wherein the indication comprises an alert that indicates the use of an alternate account.

3. The computer-implemented method of claim 2, wherein the alert is sent to a game developer for a video game during which the first set of one or more characteristics of the user interaction data was determined.

4. The computer-implemented method of claim 2, wherein the alert is sent to a fraud unit of a game platform manufacturer.

5. The computer-implemented method of claim 1, wherein determining the first set of one or more characteristics of the user interaction data comprises:
determining, using the user interaction data, a skill level of the user associated with the first player account, wherein the first set of one or more characteristics of the user interaction data comprises the skill level of the user.

6. The computer-implemented method of claim 5, wherein determining the first set of one or more characteristics of the user interaction data comprises:
executing an artificial intelligence (AI) model trained to:
receive the user interaction data as an input;
determine one or more input patterns of the user interaction data;
determine the skill level associated with the first player account by comparing the one or more input patterns to one or more existing input patterns determined using historical user interaction data; and
generate an output indicating the skill level as part of the first set of one or more characteristics.

7. The computer-implemented method of claim 5, further comprising:
determining a discrepancy between the skill level of the first set of one or more characteristics and a matchmaking rating of the first player account; and
updating the matchmaking rating of the first player account to match the skill level of the first set of one or more characteristics.

8. The computer-implemented method of claim 5, further comprising:
determining a recommended skill tier of the first player account based on the skill level of the first set of one or more characteristics and a video game accessed by the first player account, wherein the video game comprises a player matching application configured to generate a group comprising one or more players each having a respective skill level consistent with a particular skill tier; and
outputting the recommended skill tier to the player matching application.

9. The computer-implemented method of claim 1, wherein the user interaction data is generated by the user interacting with one or more of: a menu application of the gaming platform, a settings interface of the gaming platform, a video game application of the gaming platform, or an acquisition application of the gaming platform.

10. A system comprising:
one or more processors; and
one or more memories storing instructions that, upon execution by the one or more processors, configure the system to:
receive user interaction data corresponding to a first player account of a gaming platform, the user interaction data generated by a user associated with the first player account interacting with the gaming platform;
determine a first set of one or more characteristics of the user interaction data;
determine whether the first set of one or more characteristics of the user interaction data match a second set of one or more characteristics of different user interaction data associated with a second player account interacting with the gaming platform; and
based on determining that the first set of one or more characteristics match the second set of one or more characteristics, then provide an indication that the first set of one or more characteristics related to the first player account match the second set of one or more characteristics related to the second player account.

11. The system of claim 10, wherein the indication comprises an alert that indicates the use of an alternate account.

12. The system of claim 11, wherein the alert is sent to a game developer for a video game during which the first set of one or more characteristics of the user interaction data was determined.

13. The system of claim 11, wherein the alert is sent to a fraud unit of a game platform manufacturer.

14. The system of claim 10, wherein determining the first set of one or more characteristics of the user interaction data comprises:
determining, using the user interaction data, a skill level of the user associated with the first player account, wherein the first set of one or more characteristics of the user interaction data comprises the skill level of the user.

15. The system of claim 14, wherein determining the first set of one or more characteristics of the user interaction data comprises:
executing an artificial intelligence (AI) model trained to:
receive the user interaction data as an input;
determine one or more input patterns of the user interaction data;
determine the skill level associated with the first player account by comparing the one or more input patterns to one or more existing input patterns determined using historical user interaction data; and
generate an output indicating the skill level as part of the first set of one or more characteristics.

16. The system of claim 14, wherein the one or more processors are further configured to:
determine a discrepancy between the skill level of the first set of one or more characteristics and a matchmaking rating of the first player account; and
update the matchmaking rating of the first player account to match the skill level of the first set of one or more characteristics.

17. The system of claim 14, wherein the one or more processors are further configured to:
determine a recommended skill tier of the first player account based on the skill level of the first set of one or more characteristics and a video game accessed by the first player account, wherein the video game comprises a player matching application configured to generate a group comprising one or more players each having a respective skill level consistent with a particular skill tier; and
output the recommended skill tier to the player matching application.

18. The system of claim 10, wherein the user interaction data comprises user interactions with one or more of: a menu application of the gaming platform, a settings interface of the gaming platform, a video game application of the gaming platform, or an acquisition application of the gaming platform.

19. A computer-readable storage medium having stored therein program code instructions that, when executed by a processor in a computer system, cause the processor to perform a method comprising:
receiving user interaction data corresponding to a first player account of a gaming platform, the user interaction data generated by a user associated with the first player account interacting with the gaming platform;
determining a first set of one or more characteristics of the user interaction data;
determining whether the first set of one or more characteristics of the user interaction data match a second set of one or more characteristics of different user interaction data associated with a second player account interacting with the gaming platform; and
based on determining that the first set of one or more characteristics match the second set of one or more characteristics, then providing an indication that the first set of one or more characteristics related to the first player account match the second set of one or more characteristics related to the second player account.

20. The computer-readable storage medium of claim 19, wherein the indication comprises an alert that indicates the use of an alternate account.
